(19) United States
(12) Patent Application Publication
(10) Pub. No.: US 2016/0072970 A1
(43) Pub. Date: Mar. 10, 2016

(54) ELECTRONIC APPARATUS AND NONVOLATILE STORAGE MEDIUM STORING USER INTERFACE CONTROL PROGRAM

(71) Applicant: SEIKO EPSON CORPORATION, Tokyo (JP)

(72) Inventor: Takeshi KIMOTO, Shiojiri-shi (JP)

(21) Appl. No.: 14/840,903

(22) Filed: Aug. 31, 2015

(30) Foreign Application Priority Data
Sep. 8, 2014 (JP) 2014-182015

(51) Int. Cl. H04N 1/00; G06F 3/041

(52) U.S. Cl. CPC H04N 1/00408; G06F 3/0416; H04N 1/00474; H04N 1/00503; H04N 2201/0094

(57) ABSTRACT

An electronic apparatus includes a display control section that shows a graphical user interface on a screen and a reception section that receives a user's operation. In response to a first user's operation, the display control section shows a transition in which a first screen including a first element changes to a second screen including a plurality of second elements related to the first element.

### BACKGROUND

1. Technical Field

The present invention relates to electronic apparatuses and nonvolatile storage media that store user interface control programs.

2. Related Art

In some technologies known in the art, a printer driver provides a property sheet in different display modes for skilled and unskilled users (e.g., refer to JP-A-2008-71369).

### SUMMARY

When an electronic apparatus instantly changes a first screen including a few first display elements to a second screen including many detailed second display elements related to one of the first display elements, a user may have trouble understanding intuitively a relationship between the first and second display elements. An advantage of some aspects of the invention is to provide an electronic apparatus and a nonvolatile storage medium that stores a user interface control program, which are capable of helping a user to perceive related display elements.

According to an aspect of the invention, an electronic apparatus includes: a display control section that shows a graphical user interface on a screen; and a reception section that receives an operation according to the content shown on the screen from a user. When the display control section changes a first screen including a primary display element to a second screen including a plurality of secondary display elements related to the primary display element in response to a detailed screen request operation from the user, the display control section shows movement in which the plurality of secondary display elements are created from the primary display element after showing the first screen and before showing the second screen.

If the first screen instantly changes to the second screen, the user has trouble perceiving the relationship between the primary display element and the plurality of secondary display elements. The aspect of the invention, however, shows the movement in which the plurality of secondary display elements are created from the primary display element after showing the first screen and before showing the second screen. Showing the movement in this manner helps the user to perceive the relationship between the primary display element and the plurality of secondary display elements.

When the display control section changes a second screen including a plurality of secondary display elements to a first screen including a primary display element related to the plurality of secondary display elements in response to a simple screen request operation from the user, the display control section preferably shows movement in which the primary display element is created from the plurality of secondary display elements after showing the second screen and before showing the first screen. Showing the movement in this manner can help the user to perceive the relationship between the secondary display elements and the primary display element.

In the electronic apparatus described above, the primary display element in the first screen is an operation object indicating a set item, and a plurality of primary display elements corresponding to multiple set items may be included in the first screen. When the user selects a desired one of the primary display elements on the first screen, the display control section may show the setting dialogue exclusively for the set item indicated by the primary display element selected. This setting dialogue may include a plurality of display elements as a plurality of operation objects, each of which indicates selections of a corresponding parameter to be set in the set item. The plurality of secondary display elements included in the second screen may form groups, each of which is related to a corresponding one of the plurality of primary display elements. A plurality of secondary display elements belonging to one of the groups may be operation objects corresponding to selections of the setting dialogue exclusively for the set item indicated by the primary display element related to the one group.

In response to a user's selection operation of a primary display element on the first screen which indicates a set item, the configuration described above shows the setting dialogue exclusively for this set item. So, the user can select one of display elements in the setting dialogue which correspond to parameter selections. Unfortunately, if a user sets parameters for a plurality of set items, the user needs to repeat, multiple times, selecting one of primary display elements and selecting one of selections in the setting dialogue for the primary display element selected. However, in addition to the method of repeating the above operations, this configuration provides a method of setting a plurality of set items at once. More specifically, this configuration provides a second screen that includes multiple groups of secondary display elements; each group corresponds to one of primary display elements. For example, suppose a first screen includes primary display elements A1 and B1, and a second screen includes a plurality of secondary display elements A21 to A2n related to the primary display element A1 and a plurality of secondary display elements B21 to B2m related to the primary display element B1. A user only has to perform an operation of making the second screen appear (e.g., perform a detailed screen request operation) and then set a plurality of set items on the second screen. Thus, a user can set a plurality of set items through a smaller number of operations. A user may select one of the above two methods of setting set items in accordance with the number of set items to be set or a user's preference. Herein, an operation object may be implemented using a graphical user interface (GUI) component (e.g., button, switch, etc.) configured to receive a user's operation.

In the electronic apparatus described above, of the first screen including the plurality of primary display elements and the second screen including the plurality of secondary display elements related to the plurality of primary display elements, a related group of a primary display element and secondary display elements preferably share a common visual property. Further, the visual property common to this related group can preferably be distinguished from those common to other related groups. As described above, a plurality of primary display elements and a plurality of secondary display elements related to the primary display elements form a plurality of related groups. Each of the related groups shares a common visual property. The visual property common to one related group can be distinguished from those of the other related groups. Setting visual properties of display elements in this manner can help a user to perceive a relationship between a primary display element and a plurality of secondary display elements.

Another aspect of the invention can be a nonvolatile storage medium that stores a user interface control program causing an electronic apparatus to perform the foregoing operations.

### BRIEF DESCRIPTION OF THE DRAWINGS

The invention will be described with reference to the accompanying drawings, wherein like numbers reference like elements.

FIG. 1 illustrates a block diagram of an electronic apparatus in an embodiment of the invention.

FIGS. 2A to 2C illustrate exemplary displays in the embodiment of the invention.

FIGS. 3A and 3B illustrate exemplary displays in the embodiment of the invention.

FIGS. 4A to 4C illustrate exemplary displays in the embodiment of the invention.

### DESCRIPTION OF EXEMPLARY EMBODIMENTS

Embodiments of the invention will be described below with reference to the accompanying drawings. Constituent elements in the drawings which are related to one another are denoted by the same reference characters, and no overlapping descriptions will be given below.

### 1. Embodiment

### 1-1. Configuration

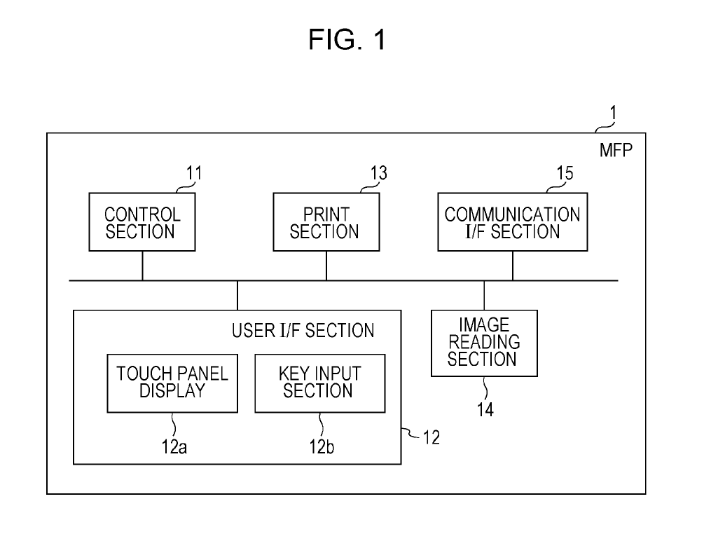

FIG. 1 illustrates a block diagram of a configuration of a multifunction printer (MFP) 1, which acts as an electronic apparatus in an embodiment of the invention. The MFP 1 includes a control section 11, a user I/F section 12, a print section 13, an image reading section 14, and a communication I/F section 15. The control section 11 is implemented using, for example a CPU, a nonvolatile memory, a RAM, and an ASIC. The CPU executes various programs, including a user interface control program, stored in the nonvolatile memory, controlling individual sections of the MFP 1 to fulfill the functions of the MFP 1. The user I/F section 12 includes a touch panel display 12a and a key input section 12b. The key input section 12b is provided with a start key, an up-arrow key, a down-arrow key, a home key, and a return key, for example.

The control section 11 causes the touch panel display 12a to show an arbitrary graphical user interface by executing the user interface control program, permitting a user's operation according to the content shown by the touch panel display 12a to be accepted through the touch panel display 12a or the key input section 12b. In short, the control section 11 functions as both a “display control section” and a “reception section,” by executing the user interface control program.

The print section 13 includes an actuator, a sensor, a drive circuit, and mechanical parts, which are used to print letters, objects, etc. on print media by using a known print system. Examples of such print media include photo paper, regular paper, and OHP sheets; examples of such known print systems include an ink jet system and an electrophotographic system. The image reading section 14 includes: a known color image sensor that emits light to an original placed on a platen and splits light reflected from the original into RGB light beams, generating scan image data; an actuator that feeds an original; a drive circuit; and mechanical parts. The communication I/F section 15 includes various communication interfaces for use in conducting wired or wireless communication with an arbitrary external apparatus.

### 1-2. Screen Transition

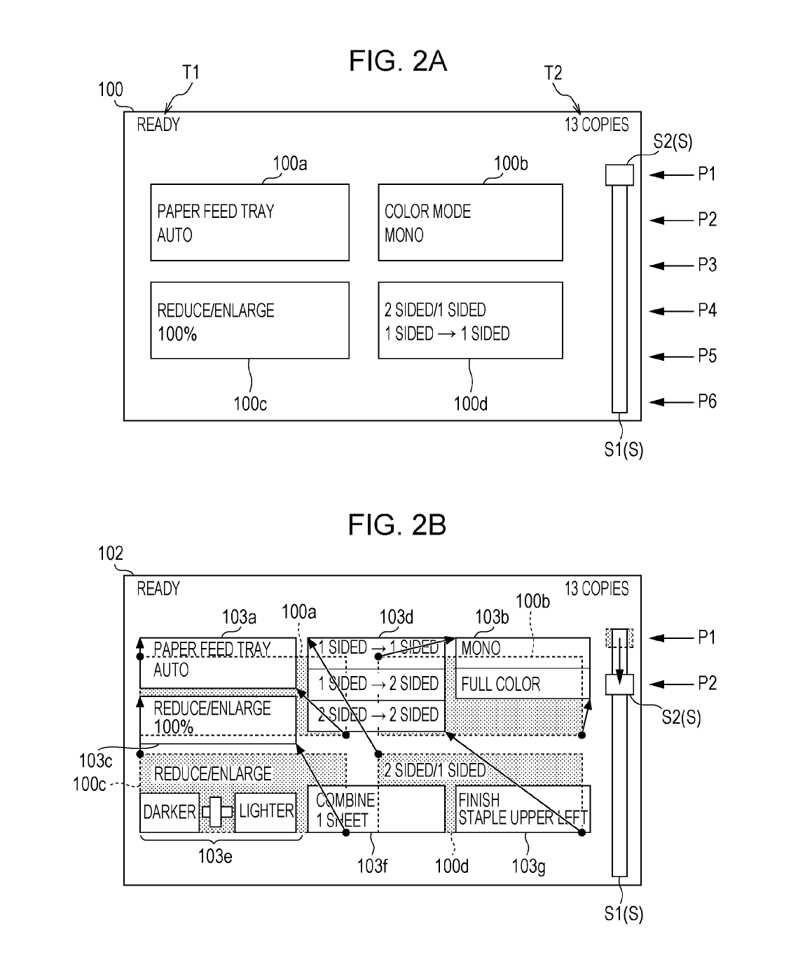

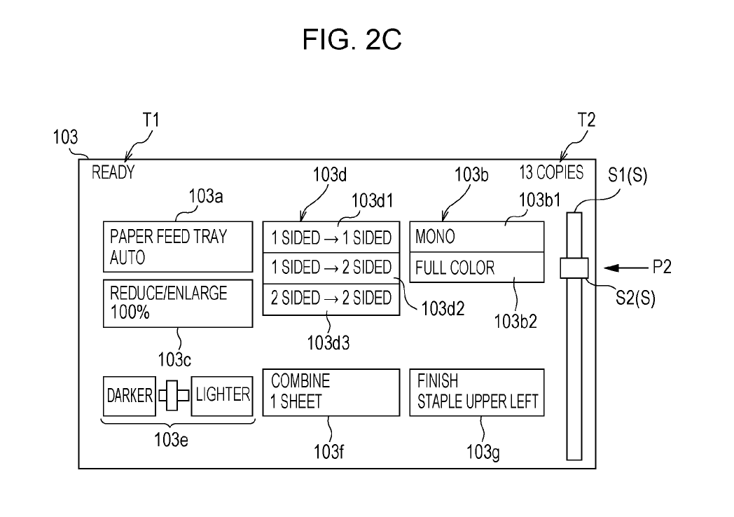

Next, a transition between menu screens in the MFP 1 will be described with reference to FIGS. 2A to 4C. FIGS. 2A to 4C each illustrate a menu screen shown by the touch panel display 12a when a copy mode is selected in the MFP 1. When a user selects a copy mode by tapping a display element for the copy mode on a home screen (not illustrated) shown by the touch panel display 12a, the control section 11 causes the touch panel display 12a to show a screen 100 illustrated in FIG. 2A. This screen 100 includes a paper feed tray setting button 100a, a color mode setting button 100b, a size magnification selection button 100c, a copy side setting button 100d, and a slider S. The screen 100 also includes guidance T1 for a user and the number of copies T2 to be set by a user through the up-arrow and down-arrow keys, for example. Display elements, called “buttons,” in this embodiment act as one type of GUI parts (operation objects) to be operated by a user.

The paper feed tray setting button 100a to the copy side setting button 100d on the screen 100 are set items in the copy mode. Although other set items are present, these four buttons appear on the initial screen 100 when the copy mode is selected. These set items on the screen 100 could be set with high frequency in the copy mode. Each of the paper feed tray setting button 100a to the copy side setting button 100d is a rectangular object that shows the menu of a set item on an upper portion and a parameter presently set as the set item on a lower portion. Referring to the color mode setting button 100b, for example, “monochrome” is set as the color mode.

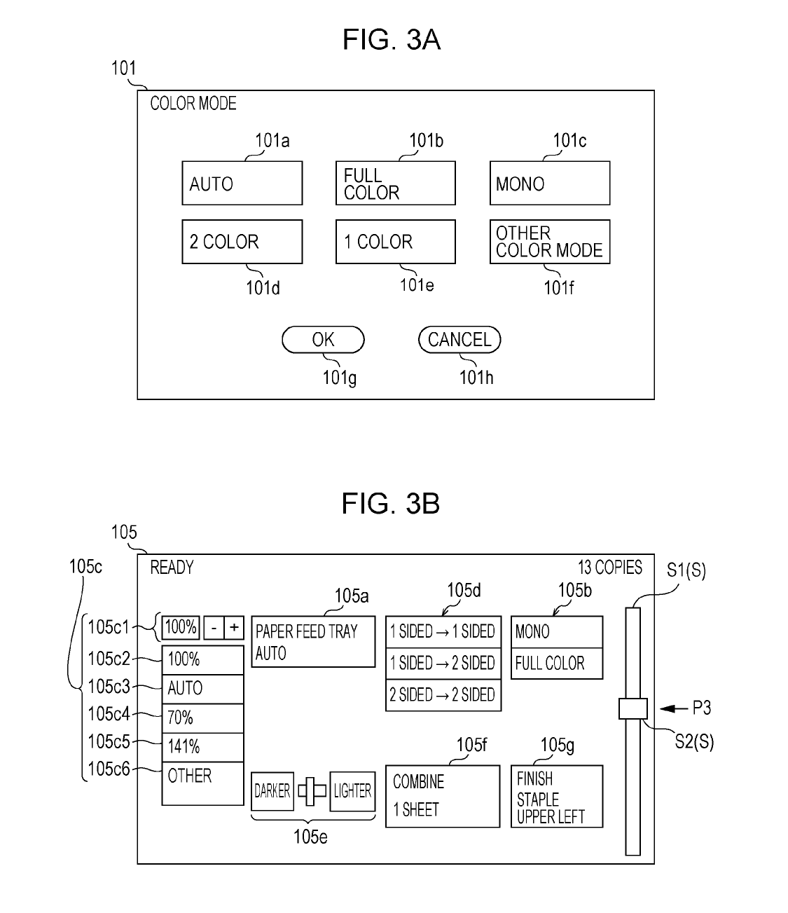

Each of the paper feed tray setting button 100a to the copy side setting button 100d on the screen 100 functions as a button for use in making setting dialogue exclusively for a corresponding set item appear in response to a user's tapping (selection operation). When a user taps the color mode setting button 100b on the screen 100, for example, the control section 11 causes the touch panel display 12a to show a color mode setting dialogue screen 101 illustrated in FIG. 3A.

The color mode setting dialogue screen 101 includes buttons 101a to 101f that indicate the selections of parameters to be set in the color mode. If a user selects one of the buttons 101a to 101f and an OK button 101g, the control section 11 sets the selected parameter as a parameter in the color mode and then causes the touch panel display 12a to show the previous screen 100 again. If a user selects a cancel button 101h on the color mode setting dialogue screen 101, the control section 11 ignores the parameter that has been selected on the color mode setting dialogue screen 101 and then causes the touch panel display 12a to show the previous screen 100. It should be noted that a setting dialogue screen may appear over the entire surface of the touch panel display 12a as illustrated in FIG. 3A or overlap the screen 100. When a button is selected, for example, the setting dialogue screen for the set item of the selected button may appear near this button in a drop-down menu format. Herein, the color mode setting dialogue screen 101 corresponds to a third screen.

The screen 100 illustrated in FIG. 2A will be described again. The slider S on the screen 100 includes a track S1 extending in a vertical direction of the touch panel display 12a and a handle S2 slidable along the track S1. A user can move the handle S2 along the track S1 by sliding his/her finger or a pointing tool vertically on the track S1. When the user moves the finger or tool off the handle S2, the handle S2 stops moving on the track S1 at one of six locations P1 to P6 in this embodiment.

When a user slides the handle S2 from the location P1 to the location P2, the control section 11 causes the touch panel display 12a to show a screen 103 illustrated in FIG. 2C. In this embodiment, an operation of sliding the handle S2 downward corresponds to a “detailed screen request operation” or a “first operation”; an operation of sliding the handle S2 upward corresponds to a “simple screen request operation” or a “second operation.” FIG. 2B illustrates a screen 102, which is used to explain movement shown during the sliding of the handle S2 from the location P1 to the location P2. In this movement, first the paper feed tray setting button 100a to the copy side setting button 100d on the screen 100 move with their locations, shapes, and the numbers of selection buttons changed and then the screen 103 having a paper feed tray setting button 103a, a color mode selection button group 103b, a size magnification selection button 103c, and a copy side selection button group 103d appear. The four hatched rectangular areas surrounded by broken lines on the screen 102 correspond to the paper feed tray setting button 100a to the copy side setting button 100d on the screen 100. It should be noted that the hatching line of each area is drawn for the sake of distinguishing the paper feed tray setting button 100a to the copy side setting button 100d from the paper feed tray setting button 103a to the copy side selection button group 103d, and these areas are not actually hatched accordingly. In FIG. 2B, the movement loci of the upper left and lower right corners of each of the paper feed tray setting button 100a to the copy side setting button 100d are indicated by arrows, although these arrows do not actually appear on the touch panel display 12a. The handle S2 is indicated by the single arrow, because the handle S2 is shifted in an extending direction of the track S1 without changing its shape. The speed of the above movement may be dependent on a manner in which a user slides the handle S2 or may be constant independent of the sliding speed or distance of the handle S2. If the movement is dependent on the sliding speed of the handle S2, as the user slides the handle S2 more slowly, the paper feed tray setting button 100a to the copy side setting button 100d preferably change more slowly. In addition, when the user stops the handle S2 between the locations P1 and P2, the paper feed tray setting button 100a to the copy side setting button 100d preferably stop changing. In this way, a user enables buttons to change in a proper speed so that the user can perceive this change.

During the sliding of the handle S2 from the location P1 to the location P2, the control section 11 moves the paper feed tray setting button 100a in the upper left direction while reducing its button size and letter size but maintaining its rectangular shape. Then, when the handle S2 arrives at the location P2, the paper feed tray setting button 103a appears. Likewise, the control section 11 moves the size magnification selection button 100c in the upper left direction while reducing its button size and letter size but maintaining its rectangular shape. Then, when the handle S2 arrives at the location P2, the size magnification selection button 103c appears. The paper feed tray setting button 103a on the screen 103 has the same function as the paper feed tray setting button 100a on the screen 100, although both sizes differ from each other. Likewise, the size magnification selection button 103c on the screen 103 has the same function as the size magnification selection button 100c on the screen 100, although both sizes differ from each other. In other words, both the paper feed tray setting button 103a and the size magnification selection button 103c also have a function of showing the setting dialogue of a corresponding set item when selected.

During the sliding of the handle S2 from the location P1 to the location P2, the control section 11 fades out the color mode setting button 100b while moving the color mode setting button 100b so as to overlap the area in which the color mode selection button group 103b will appear. Then, the control section 11 fades in the color mode selection button group 103b before the sliding of the handle S2 is terminated. Consequently, when the handle S2 arrives at the location P2, the color mode setting button 100b has disappeared and the color mode selection button group 103b appears instead, as illustrated in FIG. 2C. In this case, a user can feel as if the color mode setting button 100b has been broken up to create the color mode selection button group 103b. The color mode selection button group 103b on the screen 103 has a monochrome button 103b1 and a full color button 103b2, which are selections of a parameter to be set as a set item in the color mode. When a user taps (selects) one of the monochrome button 103b1 and the full color button 103b2 on the screen 103, the control section 11 sets a corresponding one of “monochrome” and “full color” as the selected parameter in the color mode.

During the sliding of the handle S2 from the location P1 to the location P2, the control section 11 fades out the copy side setting button 100d while moving the copy side setting button 100d so as to overlap the area in which the copy side selection button group 103d will appear. Then, the control section 11 fades in the copy side selection button group 103d before the sliding of the handle S2 is terminated. Consequently, when the handle S2 arrives at the location P2, the copy side setting button 100d has disappeared and the copy side selection button group 103d appears instead, as illustrated in FIG. 2C. In this case, a user can feel as if the copy side setting button 100d has been broken up to create the copy side selection button group 103d. The copy side selection button group 103d has a “1 SIDED→1 SIDED” button 103d1, a “1 SIDED→2 SIDED” button 103d2, and a “2 SIDED→2 SIDED” button 103d3. The “1 SIDED→1 SIDED” button 103d1 to the “2 SIDED→2 SIDED” button 103d3 are selections of a parameter to be set as a set item for a “1 sided/2 sided selection.”

A user can make a setting dialogue appear on the screen 100 by tapping one of the paper feed tray setting button 100a to the copy side setting button 100d. The user can subsequently select one of the parameters of the set item in the setting dialogue, after which the screen 100 appears again. Through these operations, various parameters can be set. Alternatively, a user can make selections of each of the parameters for a plurality of set items (two set items in this case) appear by sliding the handle S2 on the screen 100 to the location P2. The user can subsequently select one of the selections of each parameter on the screen 103. This operation involves a smaller number of operational steps, thus providing better operability. In general, if a plurality of set items are unfolded (provide a plurality of selections) instantly, namely, if the screen 100 changes to the screen 103 instantly in response to a single slide operation, a user may have trouble understanding which set item has been unfolded to show selections. In this embodiment, however, the screen 100 does not instantly change to the screen 103. More specifically, when the screen 100 changes to the screen 103, the MFP 1 shows the process of movement in which display elements move with their shapes changed and the number of buttons increased. Showing the movement process in this manner can help a user to perceive a relationship between a set item on the screen 100 and selections on the screen 103 which correspond to the set item.

Herein, the screen 100 corresponds to a “first screen,” and screen 103 a “second screen.” Both the copy side setting button 100d and the color mode setting button 100b correspond to a “primary display element” or a “first element.” The buttons 103d1 to 103d3 in the copy side selection button group 103d correspond to “a plurality of secondary display elements” or “a plurality of second elements” related to the copy side setting button 100d. Likewise, the buttons 103b1 to 103b2 in the color mode selection button group 103b correspond to “a plurality of secondary display elements” or “a plurality of second elements” related to the color mode setting button 100b.

In this embodiment, the rectangular paper feed tray setting button 100a has a yellow background behind the letters. The paper feed tray setting button 103a also has a yellow background. Both the color mode setting button 100b and the color mode selection button group 103b have a green background. Both the size magnification selection buttons 100c and 103c have a light blue background. Both the copy side setting button 100d and the copy side selection button group 103d have a pink background. As described above, each related pair of buttons shares a common background color, which is different from those common to other related pairs. Consequently, when a screen changes to another screen, a user can perceive a relationship between buttons on both screens clearly and effectively. In addition to colors, shapes and other visual properties may be used to help a user to perceive a relationship between buttons.

A display element that has not appeared on the screen 100 newly fades in and appears on the screen 103. More specifically, the control section 11 shows new buttons within a region below buttons or button groups related to the paper feed tray setting button 100a to the copy side setting button 100d on the screen 100. Such new buttons shown by the control section 11 are a density adjusting part 103e, a combination setting button 103f, and a finish setting button 103g. The density adjusting part 103e has a slider and buttons for use in adjusting the print density. These density adjusting part 103e, combination setting button 103f, and finish setting button 103g correspond to set items in the copy mode. Each of the density adjusting part 103e, the combination setting button 103f, and the finish setting button 103g employs a background color different from other button and button groups. The color of the set items will be maintained in subsequent screen transitions.

When a user slides the handle S2 from the location P2 to the location P1, the movement made when the screen 100 changes to the screen 103 is shown in a reverse manner. More specifically, during this movement, the control section 11 fades out the density adjusting part 103e, the combination setting button 103f, and the finish setting button 103g. Simultaneously, the control section 11 fades out the paper feed tray setting button 103a and the size magnification selection button 103c while moving the paper feed tray setting button 103a and the size magnification selection button 103c in a direction opposite to that of the arrows in FIG. 2B, and fades in the paper feed tray setting button 100a and the size magnification selection button 100c instead. In addition, the control section 11 also fades out the copy side selection button group 103d and the color mode selection button group 103b while moving the copy side selection button group 103d and the color mode selection button group 103b in a direction opposite to that of the arrows in FIG. 2B, and fades in the copy side setting button 100d and the color mode setting button 100b instead. This movement makes the user feel as if the monochrome button 103b1 and the full color button 103b2 of the color mode selection button group 103b have been combined to create the color mode setting button 100b. As described above, when the screen 103 changes to the screen 100, the MFP 1 shows a process in which display elements move and the number of display elements is decreased, helping a user to perceive a relationship between buttons more clearly and effectively.

Suppose a user further slides the handle S2 on the screen 103 from the location P2 to the location P3. During the sliding, the control section 11 changes the locations, shapes and number of display elements. When the handle S2 arrives at the location P3, the control section 11 causes the touch panel display 12a to show a screen 105 illustrated in FIG. 3B. More specifically, the control section 11 decreases the lateral width of the color mode selection button group 103b by gradually moving the left side of the color mode selection button group 103b in the right direction, showing a color mode selection button group 105b. Likewise, the control section 11 decreases the lateral width of the copy side selection button group 103d while moving the copy side selection button group 103d in the right direction, showing a copy side selection button group 105d. Likewise, the control section 11 decreases the lateral width of the paper feed tray setting button 103a while moving the paper feed tray setting button 103a in the right direction, showing a paper feed tray setting button 105a. The control section 11 decreases the sizes of the density adjusting part 103e, the combination setting button 103f, and the finish setting button 103g while moving the density adjusting part 103e, the combination setting button 103f, and the finish setting button 103g in the right direction, showing a density adjusting part 105e, a combination setting button 105f, and a finish setting button 105g.

When the screen 103 changes to the screen 105, the control section 11 shows movement in which the size magnification setting button group 105c is created from the size magnification selection button 103c. More specifically, the control section 11 fades out the size magnification selection button 103c while deforming and moving the size magnification selection button 103c so as to overlap the area in which the size magnification setting button group 105c will appear. Simultaneously, the control section 11 fades in size magnification selection button groups 105c2 to 105c6 and also fades in a size magnification adjusting part 105c1 above the size magnification selection button groups 105c2 to 105c6. These size magnification selection button groups 105c2 to 105c6 are selections of the parameter of the set item in the size magnification. The size magnification adjusting part 105c1 includes a region in which a size magnification presently set is shown and (+) and (−) buttons for use in finely adjusting the size magnification. A user can set the size magnification precisely by using those buttons. Showing the movement in which the size magnification setting button group 105c is created from the size magnification selection button 103c helps a user to perceive the relationship therebetween. Assuming that the screen 103 is a “first screen” and the screen 105 is a “second screen,” the size magnification selection button 103c corresponds to a “primary display element” or a “first element,” and the size magnification setting button group 105c corresponds to “a plurality of secondary display elements” or “a plurality of second elements.”

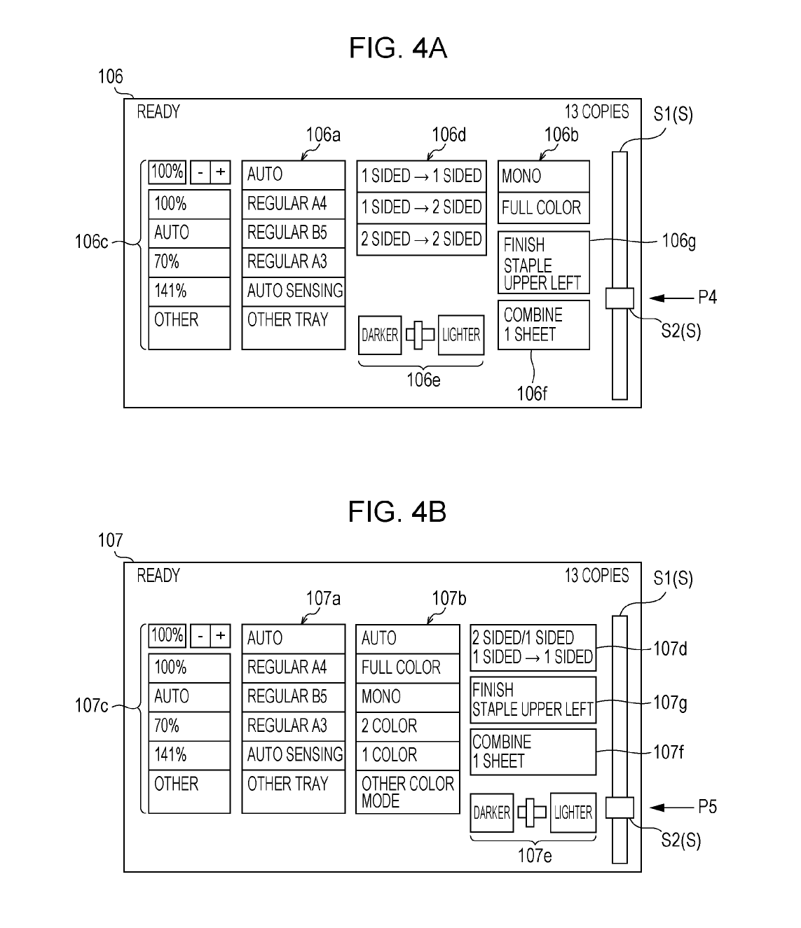

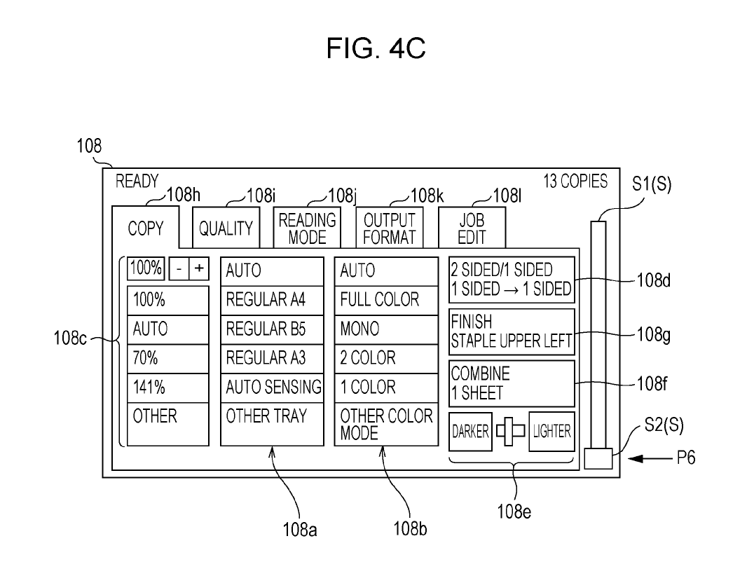

Suppose a user further slides the handle S2 from the location P3 to the location P4. During the sliding, the control section 11 gradually changes the display elements on the screen 105, causing the touch panel display 12a to show a screen 106 illustrated in FIG. 4A. More specifically, the control section 11 fades out the paper feed tray setting button 105a while deforming the paper feed tray setting button 105a (expanding the lateral size thereof) so as to overlap an area in which a paper feed tray selection button group 106a will appear. Simultaneously, the control section 11 fades in the paper feed tray selection button group 106a, showing the paper feed tray selection button group 106a on the screen 106 instead of the paper feed tray setting button 105a. The paper feed tray selection button group 106a is made up of selections of the parameter of the set item in the paper feed tray. Furthermore, the control section 11 moves the density adjusting part 105e in the right direction and then shows it as a density adjusting part 106e. The control section 11 moves the finish setting button 105g in the upward direction and then shows it as a finish setting button 106g. The control section 11 moves the combination setting button 105f in the right direction and then shows it as a combination setting button 106f. The control section 11 shows the size magnification setting button group 105c as a size magnification setting button group 106c without any changes except, for example a fine size adjustment according to the overall layout.

Suppose a user further slides the handle S2 from the location P4 to the location P5. During the sliding, the control section 11 gradually changes the display elements on the screen 106, causing the touch panel display 12a to show a screen 107 illustrated in FIG. 4B. More specifically, the control section 11 fades out a copy side selection button group 106d while deforming and moving the copy side selection button group 106d so as to overlap an area in which a copy side setting button 107d will appear. Simultaneously, the control section 11 fades in the copy side setting button 107d. The copy side setting button 107d has the same function as the copy side setting button 100d on the screen 100. More specifically, when a user taps the copy side setting button 107d, a copy side setting dialogue appears. The control section 11 moves the finish setting button 106g and the combination setting button 106f in the upward direction and then shows them as a finish setting button 107g and a combination setting button 107f, respectively. The control section 11 moves the density adjusting part 106e in the right direction and then shows it as a density adjusting part 107e.

The control section 11 moves a color mode selection button group 106b in the left direction while fading in a plurality of buttons corresponding to remaining selections in the color mode, showing a color mode selection button group 107b. As a result, the number of selections of the parameter to be set in the color mode is increased on the screen 107, and more detailed setting is thus possible. In this way, all the selections do not have to be shown at once. Alternatively, selections that could be selected with high frequency may be shown at first, and then when the detailed screen request operation is performed, all the selections including remaining selections may be shown. This can provide better operability especially for unskilled users, because showing only selections to be set easily at first could be more convenient for such unskilled users than showing all the detailed selections at once. The control section 11 does not change the paper feed tray selection button group 106a and the size magnification setting button group 106c on the screen 106 and use them as a paper feed tray selection button group 107a and a size magnification setting button group 107c, respectively.

Suppose a user further slides the handle S2 from the location P5 to the location P6. During the sliding, the control section 11 gradually changes the display elements on the screen 107, showing a screen 108 illustrated in FIG. 4C. More specifically, the control section 11 moves, in the downward direction, all of the paper feed tray selection button group 107a, the color mode selection button group 107b, the size magnification setting button group 107c, the copy side setting button 107d, the finish setting button 107g, the combination setting button 107f, and the density adjusting part 107e shown on the screen 107. Then, the control section 11 fades in a plurality of tabs 108h to 108l and shows, within a copy tab 108h of these tabs, the paper feed tray selection button group 107a, the color mode selection button group 107b, the size magnification setting button group 107c, the copy side setting button 107d, the finish setting button 107g, the combination setting button 107f, and the density adjusting part 107e.

As described above, a user can slide the handle S2 along the slider S from the location P1 to the location P6, whereby a simple screen including a small number of buttons is gradually changed to a detailed screen including a large number of selection button groups and adjusting parts. This gradual change helps the user to perceive a relationship between display elements. Also, the user can change the detailed screen to the simple screen by sliding the handle S2 from the location P6 to the location P1. In short, the user can make screens 100, 103, 105, 106, 107, and 108 appear in this or reverse order by sliding the handle S2. Herein, the expression “showing movement” refers to “showing a transition process.”

### 2. Other Embodiment

The technical scope of the invention is not limited to the embodiment described above, and this embodiment may undergo various modifications, including one or more of modifications that will be described below, without departing from the spirit of the invention. To give some examples, the detailed screen request operation may be a pinch-out operation to be performed on the screen of the touch panel display 12a at a predetermined location, and the simple screen request operation may be a pinch-in operation to be performed on the screen at a predetermined location. The detailed screen request operation may be an operation in which a user's finger or any pointing tool touches the touch panel display 12a and moves thereon circularly in the clockwise direction, and the simple screen request operation may be an operation in which a user's finger or any pointing tool touches the touch panel display 12a and moves thereon circularly in the counterclockwise direction. Each of the detailed screen request operation and the simple screen request operation may be performed by operating a predetermined key in the key input section 12b or both the key input section 12b and the touch panel display 12a.

In the foregoing description, an electronic apparatus in an embodiment of the invention is applied to an MFP. However, the electronic apparatus is applicable to personal computers (PCs), vehicles, and other apparatuses. A display control section in the electronic apparatus may be implemented using an external display having a screen on which graphical user interfaces can appear. A reception section in the electronic apparatus may be an external input device that accepts input operations.

In the foregoing embodiment, a related group of a primary display element and secondary display elements shares a common visual property, namely, a region with the same color (same background color) within the button frame other than letters, although this color is different from those of other related pairs. This visual property, however, may employ another aspect. To give an example, individual related groups of a primary display element and secondary display elements may have different hues, and each related group may have the same hue. To give another example, a pattern, such as a mark or an icon, may be set for each related group of a primary display element and secondary display elements. Each related group of a primary display element and secondary display elements may have the same pattern, and this pattern can be distinguished from those of other related groups of a primary display element and secondary display elements.

In the foregoing embodiment, an electronic apparatus accepts the tapping of a button on a screen corresponding to one of locations P1 to P6 at which a handle S2 of a slider S stops. However, the electronic apparatus may accept a user's operation for a button in the course of a transition (movement) between screens.

Movement in which a plurality of secondary display elements are created from a primary display element or a primary display element is created from a plurality of secondary display elements is not limited to that described in the foregoing embodiment. Alternatively, an arbitrary animation or an image may appear during the movement in order to help a user to perceive a relationship between related display elements. When secondary display elements are created on a second screen from a primary display element, this primary display element may still be present on the second screen. In other words, a primary display element and a plurality of secondary display elements corresponding thereto may be present together on the second screen. Of transitions in which a plurality of secondary display elements are created from a primary display element and in which a primary display element is created from a plurality of secondary display elements, only one may be shown. In this case, screens between which the other transition is made may be changed instantly.

The entire disclosure of Japanese Patent Application No.2014-182015, filed Sep. 8, 2014 is incorporated by reference herein.

What is claimed is:

1. An electronic apparatus comprising:
a display control section that shows a graphical user interface on a screen; and
a reception section that receives a user's operation,
in response to a first user's operation, the display control section showing a transition in which a first screen including a first element changes to a second screen including a plurality of second elements related to the first element.

2. The electronic apparatus according to claim 1, wherein
in response to a user's selection operation of the first element, the display control section shows a third screen including at least a first selection and a second selection,
the first selection corresponds to a first one of the plurality of second elements related to the first element, and
the second selection corresponds to a second one of the plurality of second elements related to the first element.

3. The electronic apparatus according to claim 1, wherein
in response to the first user's operation, the display control section shows a transition in which a first screen including the first element and a third element changes to a second screen including the plurality of second elements related to the first element and a plurality of fourth elements related to the third element, and
the first element and the second elements share a common visual property, the third element and the fourth elements share a common visual property, and the visual property common to the first and second elements is different from that common to the third and fourth elements.

4. The electronic apparatus according to claim 1, wherein
in response to the first user's operation, the display control section shows the transition in which the first screen changes to the second screen as if the first element has been broken up to create the second elements.

5. An electronic apparatus comprising:
a display control section that shows a graphical user interface on a screen; and
a reception section that receives a user's operation,
in response to a second user's operation, the display control section shows a transition in which a second screen including a plurality of second elements changes to a first screen including a first element related to the plurality of second elements.

6. The electronic apparatus according to claim 5, wherein
in response to the second user's operation, the display control section shows a transition in which a second screen including the plurality of second elements and a plurality of fourth elements changes to a first screen including the first element and a third element related to the fourth elements, and
the first element and the second elements share a common visual property, the third elements and the fourth element share a common visual property, and the visual property common to the first and second elements is different from that common to the third and fourth elements.

7. The electronic apparatus according to claim 5 wherein
in response to the second user's operation, the display control section shows the transition in which the second screen changes to the first screen as if the second elements have been combined to create the first element.

8. A nonvolatile storage medium storing a user interface control program causing a computer to fulfil:
a display control function of displaying a graphical user interface on a screen; and
a reception function of receiving a user's operation,
in response to a first user's operation, the display control function showing a transition in which a first screen including a first element changes to a second screen including a plurality of second elements related to the first element.

9. A nonvolatile storage medium storing a user interface control program causing a computer to fulfil:
a display control function of displaying a graphical user interface on a screen; and
a reception function of receiving a user's operation,
in response to a second user's operation, the display control function showing a transition in which a second screen including a plurality of second elements changes to a first screen including a first element related to the plurality of second elements.
